(19) United States
(12) Patent Application Publication
(10) Pub. No.: US 2013/0333212 A1
(43) Pub. Date: Dec. 19, 2013

(54) METHOD OF MANUFACTURING AN IMPINGEMENT SLEEVE FOR A TURBINE ENGINE COMBUSTOR

(71) Applicants: Prasanna Simha Janardhan, Bangalore (IN); Srinivasa Rao Konakalla, Bangalore (IN)

(72) Inventors: Prasanna Simha Janardhan, Bangalore (IN); Srinivasa Rao Konakalla, Bangalore (IN)

(73) Assignee: GENERAL ELECTRIC COMPANY, Schenectady, NY (US)

(21) Appl. No.: 13/523,454

(22) Filed: Jun. 14, 2012

(51) Int. Cl. B23K 3/00

(52) U.S. Cl. 29/888.012

(57) ABSTRACT

According to one aspect of the invention, a method of manufacturing an impingement sleeve for a turbine engine combustor includes placing a first metal sheet in a first die, pressing the first metal sheet in the first die to form a first vertical half of the impingement sleeve, placing a second metal sheet in a second die and pressing the second metal sheet in the second die to form a second vertical half of the impingement sleeve. The method also includes forming holes in the first vertical half and second vertical half while the first vertical half and second vertical half remain separate, positioning the first vertical half and second vertical half about a transition piece and welding the first vertical half to the second vertical half to form the impingement sleeve.

### BACKGROUND OF THE INVENTION

The subject matter disclosed herein relates to turbine engines. More particularly, the subject matter relates to impingement sleeves located in turbine combustors.

In gas turbine engines, a combustor converts chemical energy of a fuel or an air-fuel mixture into thermal energy. The thermal energy is conveyed by a fluid, often air from a compressor, via a transition piece to a turbine where the thermal energy is converted to mechanical energy. These fluids flow downstream to one or more turbines that extract energy therefrom to produce the mechanical energy output as well as power to drive the compressor.

Manufacturing these components can be a complex process given the size of the parts and the extreme conditions that the assembly is exposed to during use. For example, combustion dynamics and combustion temperatures in selected locations, such as the combustor assembly, may lead to thermal stress and wear of parts in the assemblies. In some cases, the combustor assembly includes an impingement sleeve disposed about the transition piece, where joints formed during manufacturing reduce the structural integrity of the impingement sleeve. Specifically, an increased number of joints can reduce the structural integrity of the sleeve, causing degradation over time that can lead to costly servicing and downtime for the turbine engine.

### BRIEF DESCRIPTION OF THE INVENTION

According to one aspect of the invention, a method of manufacturing an impingement sleeve for a turbine engine combustor includes placing a first metal sheet in a first die, pressing the first metal sheet in the first die to form a first vertical half of the impingement sleeve, placing a second metal sheet in a second die and pressing the second metal sheet in the second die to form a second vertical half of the impingement sleeve. The method also includes forming holes in the first vertical half and second vertical half while the first vertical half and second vertical half remain separate, positioning the first vertical half and second vertical half about a transition piece and welding the first vertical half to the second vertical half to form the impingement sleeve.

According to another aspect of the invention, a method of manufacturing an impingement sleeve for a turbine engine combustor includes forming a first vertical half of the impingement sleeve from a first metal sheet and forming a second vertical half of the impingement sleeve from a second metal sheet. The method also includes forming holes in the first vertical half and second vertical half while the first vertical half and second vertical half remain separate, positioning the first vertical half and second vertical half about a transition piece and coupling the first vertical half to the second vertical half to form the impingement sleeve, wherein the first vertical half and second vertical are not cut prior to coupling.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a sectional side view of an embodiment of gas turbine combustor including an impingement sleeve;

FIG. 2 is a perspective view of the impingement sleeve from FIG. 1 during a manufacturing process according to one embodiment;

FIG. 3 is perspective view of the impingement sleeve from FIGS. 1 and 2 during a manufacturing process according to one embodiment; and

FIG. 4 is a flow chart of exemplary steps that may be included in a manufacturing process for an impingement sleeve of a combustor.

The detailed description explains embodiments of the invention, together with advantages and features, by way of example with reference to the drawings.

### DETAILED DESCRIPTION OF THE INVENTION

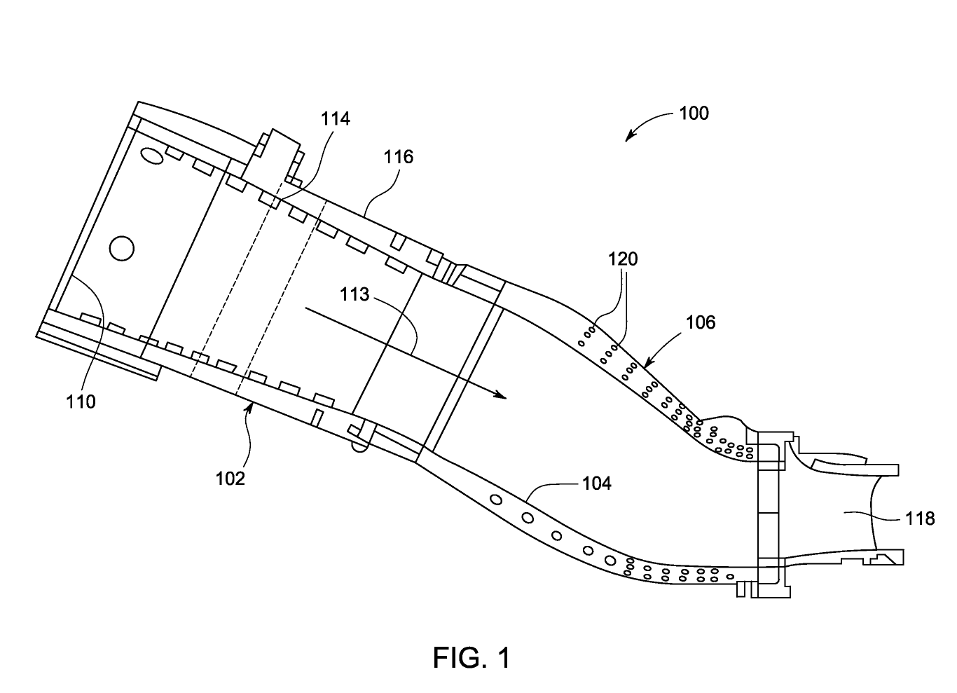

FIG. 1 is a sectional side view of a portion of an embodiment of a gas turbine combustor 100. The combustor 100 includes a combustion chamber 102, transition piece 104 and impingement sleeve 106. Fuel nozzles (not shown) mix a supply of fuel and a supply of compressed air and direct the mixture into the combustion chamber 102, where the fuel-air mixture combusts to provide a fluid flow along a hot gas path 113. The combustion chamber 102 includes a liner 114 positioned within a flow sleeve 116, wherein an air supply is directed through flow holes in the liner 114 to provide air to the combustion chamber 102. The hot gas flows downstream 113 from the combustion chamber 102 through the transition piece 104 to a first stage of a turbine 118. In an embodiment, the impingement sleeve 106 includes holes 120 configured to control a flow of fluid into or out of the transition piece 104.

As used herein, “downstream” and “upstream” are terms that indicate a direction relative to the flow of working fluid through the turbine. As such, the term “downstream” refers to a direction that generally corresponds to the direction of the flow of working fluid, and the term “upstream” generally refers to the direction that is opposite of the direction of flow of working fluid. The term “radial” refers to movement or position perpendicular to an axis or center line. It may be useful to describe parts that are at differing radial positions with regard to an axis. In this case, if a first component resides closer to the axis than a second component, it may be stated herein that the first component is “radially inward” of the second component. If, on the other hand, the first component resides further from the axis than the second component, it can be stated herein that the first component is “radially outward” or “outboard” of the second component. The term “axial” refers to movement or position parallel to an axis. Finally, the term “circumferential” refers to movement or position around an axis. Although the following discussion primarily focuses on gas turbines, the concepts discussed are not limited to gas turbines and may apply to any suitable rotating machinery, including steam turbines. Accordingly, the discussion herein is directed to gas turbine embodiments, but may apply to other turbomachinery.

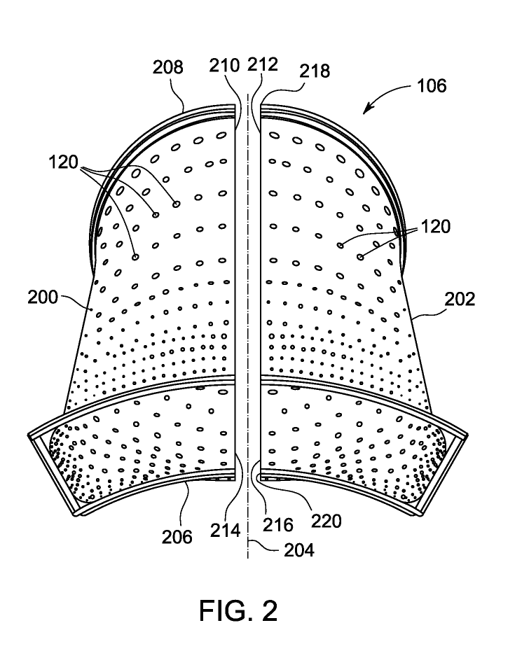

FIG. 2 is a perspective view of the impingement sleeve 106 during a manufacturing process according to one embodiment. The impingement sleeve 106 is shown with a first vertical half 200 separate from a second vertical half 202. The first vertical half 200 and second vertical half 202 are each formed by placing a flat sheet of material in a die or press. The sheet is then pressed to the desired shape, such as the shapes of the depicted first and second vertical halves 200, 202. The first vertical half 200 and second vertical half 202 are disposed about an axis 204 that is substantially parallel to the hot gas path 113 flowing through the combustor 100 and into the turbine 118 nozzle. In an embodiment of a combustor assembly, the impingement sleeve 106 has a first end 206 that is coupled to the combustion chamber 102 and a second end 208 that is coupled to a stage one nozzle of the turbine 118. Longitudinal edges 210 and 214 of the first vertical half 200 abut and are coupled to longitudinal edges 212 and 216 of the second vertical half 202, respectively, to form the whole impingement sleeve 106. Thus, after joining, the impingement sleeve 106 has longitudinal couplings at a center 218 of a top and a center 220 of a bottom of the impingement sleeve 106. In addition, the center 218 of the top and center 220 of the bottom are diametrically opposed locations in the sleeve. By forming the impingement sleeve 106 with only two couplings, structural rigidity is enhanced while manufacturing is simplified, as compared to sleeves assembled from four or more members. In an embodiment, holes 120 are formed in the first vertical half 200 and second vertical half 202 to enable flow of a fluid, such as air to and/or from the transition piece 104. The holes 120 may be formed by any suitable method, such as laser drilling or machining.

The first vertical half 200 and second vertical half 202 may be made from sheets of suitable durable material, such as a steel alloy. Exemplary materials include austenitic stainless steel having grades of 304, 310 or 347. The vertical halves are formed by pressing the sheets in a suitable pressing machine or die, where the sheets are at a selected temperature during the pressing operation. In embodiments where the final geometry or shape of the first vertical half 200 and second vertical half 202 is complex (e.g., sharp angles or curves), the pressing process may include two, three or more sequential pressing operations, where each pressing operation uses a different press or die machine. Accordingly, when a plurality of presses are employed, each press progressively shapes the sheet further until the final press produces the desired final geometry for the part of the impingement sleeve. In an embodiment, a plurality of presses are used to form impingement sleeves for turbine engines with a relatively low number of combustors, such as an engine with 5, 6, 7 or 8 combustors. This is due to the geometry of the half, such as the radial curvature of the opening at the second end 208 of the impingement sleeve. In other embodiments, a single press may be used to form impingement sleeves for turbine engines with a relatively high number of combustors, such as an engine with 13, 14, 15 or 16 combustors, where the radial curvature of the parts is gradual. The holes 222 in the first and second vertical halves 200, 202 may be formed by a suitable method, such as machining, laser drilling or water jet machining.

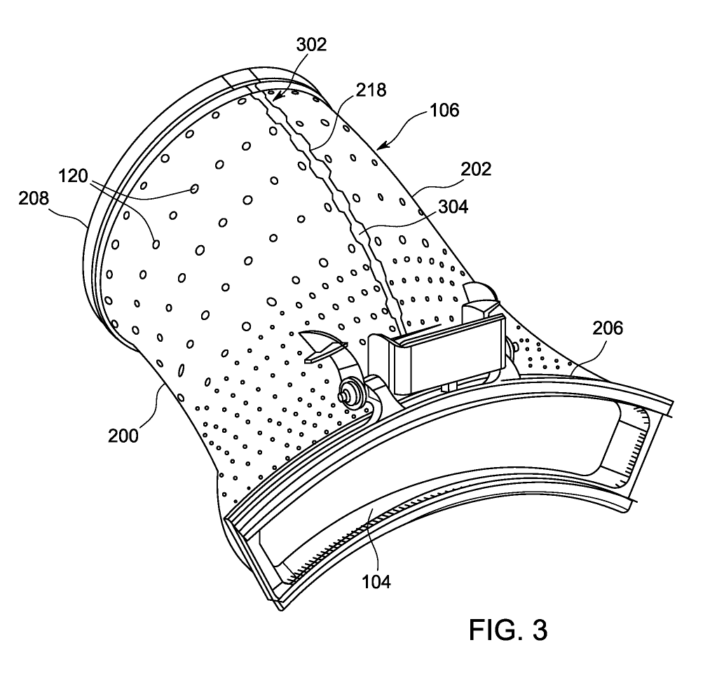

FIG. 3 is a perspective view of the impingement sleeve 106 at an assembled stage of a manufacturing process according to one embodiment. As depicted, the impingement sleeve 106 is positioned about the transition piece 104. In an embodiment, the first vertical half 200 and second vertical half 202 are each positioned about the transition piece 104 and coupled together by a suitable and durable coupling 302 at the center 218 of the top and center 220 of the bottom (not shown in FIG. 3). The following description of couplings 302 pertains to couplings at each of the centers 218, 220, though FIG. 3 only shows the coupling 302 located at center 318. As depicted, each coupling 302 includes a strip 304 placed over abutting longitudinal edges 210 and 212 of the vertical halves. After placement on the joint, the strip 304 is then coupled to each of the first vertical half 200 and second vertical half 202. In one embodiment, the strip 304 is welded to each vertical half, where the vertical halves 200, 202 are not welded directly to one another. In another embodiment, the vertical halves 200, 202 are welded together, the strip 304 is placed over the joint and the strip is then welded to each vertical half. In yet another embodiment without the strip 304, the vertical halves 200, 202 are welded together and no additional members are used to provide the coupling 302. Other suitable coupling methods may be used for joining vertical halves 200, 202 may also be used, such as brazing, adhesives and/or fasteners.

In an embodiment, the first vertical half 200 and second vertical half 202 are coupled without any cutting of the halves between the pressing operation and the coupling operation. For example, the vertical halves are not cut longitudinally to simplify positioning and assembly of the impingement sleeve 106 about the transition piece. Accordingly, structural integrity of the sleeve is enhanced while the manufacturing process is simplified. For example, in embodiments, a combustor assembly includes an impingement sleeve disposed about a transition piece, where the sleeve comprises four or more parts. The parts are joined together at joints that can reduce the structural integrity of the impingement sleeve. Further, cutting operations during assembly can also contribute to the number of joints in the impingement sleeve. Accordingly, the increased number of joints can cause degradation over time that can lead to costly servicing and downtime for the turbine engine. Thus, the depicted impingement sleeve 106 is disposed about the transition piece with a reduced number of joints and simplified assembly to reduce downtime and simplify assembly of the combustor. Therefore, embodiments of impingement sleeve 106 provide reduced manufacturing costs and improved structural durability.

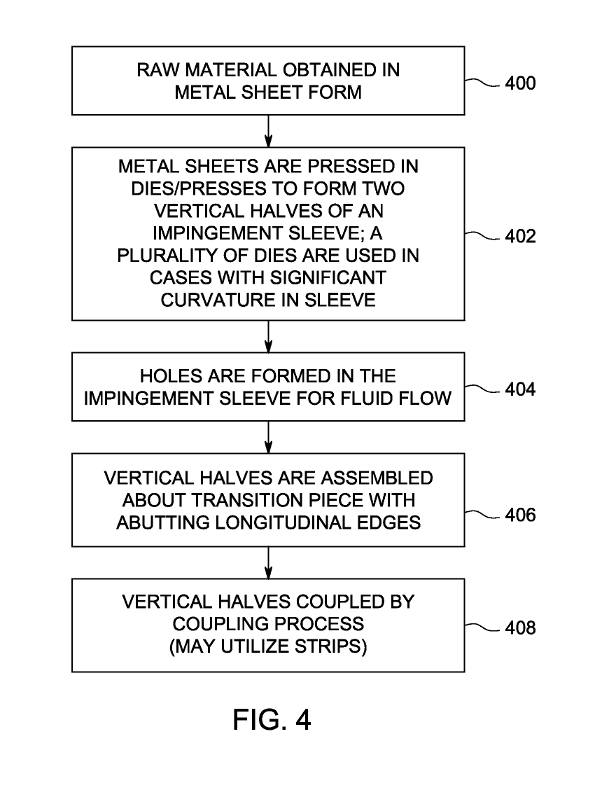

FIG. 4 is a flow chart of exemplary steps that may be included in a manufacturing or assembly process for an impingement sleeve of a combustor, such as the impingement sleeve 106. The depicted blocks may be part of or in addition to another process and/or may be performed in any suitable order to provide an impingement sleeve for a combustor. In block 400, raw material, in the form of a sheet, is obtained for the manufacturing process. In embodiments, the sheet is a metal alloy, such as stainless steel. In an example, two metal sheets are obtained where each sheet forms half of the impingement sleeve. In block 402, the metal sheets are pressed in presses or dies to form each vertical half of the impingement sleeve. In block 404, holes are formed in each vertical half for fluid flow through the impingement sleeve. In an embodiment, the holes are formed after pressing while each half is separate. In another embodiment, the holes are formed after the vertical halves are coupled. In yet another embodiment, the holes are formed before the sheets are pressed into the vertical half geometries. In block 406, the vertical halves are assembled about a transition piece where longitudinal edges of each half abut longitudinal edges of the other half. In block 408, the vertical halves are then coupled by a suitable process, such as welding or brazing.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of manufacturing an impingement sleeve for a turbine engine combustor, the method comprising:
placing a first metal sheet in a first die;
pressing the first metal sheet in the first die to form a first vertical half of the impingement sleeve;
placing a second metal sheet in a second die;
pressing the second metal sheet in the second die to form a second vertical half of the impingement sleeve;
forming holes in the first vertical half and second vertical half while the first vertical half and second vertical half remain separate;
positioning the first vertical half and second vertical half about a transition piece; and
welding the first vertical half to the second vertical half to form the impingement sleeve.

2. The method of claim 1, wherein welding the first vertical half to the second vertical half comprises forming the impingement sleeve with only two couplings where longitudinal edges of the first vertical half and second vertical half abut each other.

3. The method of claim 2, wherein welding the first vertical half to the second vertical half comprises welding a strip longitudinally along each of the two couplings.

4. The method of claim 2, wherein the two couplings are longitudinal couplings that are diametrically opposed couplings located at a center of a top of the impingement sleeve and a center of a bottom of the impingement sleeve.

5. The method of claim 1, wherein pressing the first metal sheet in the first die to form the first vertical half comprises pressing the first metal sheet a plurality of times in a plurality of dies to form the first vertical half and wherein pressing the second metal sheet in the second die to form the second vertical half comprises pressing the second metal sheet a plurality of times in a plurality of dies to form the second vertical half.

6. The method of claim 1, wherein the first vertical half and second vertical half are not cut prior to welding.

7. The method of claim 1, wherein forming holes in the first vertical half and second vertical half comprises laser drilling the holes in the first vertical half and second vertical half.

8. A method of manufacturing an impingement sleeve for a turbine engine combustor, the method comprising:
forming a first vertical half of the impingement sleeve from a first metal sheet;
forming a second vertical half of the impingement sleeve from a second metal sheet;
forming holes in the first vertical half and second vertical half while the first vertical half and second vertical half remain separate;
positioning the first vertical half and second vertical half about a transition piece; and
coupling the first vertical half to the second vertical half to form the impingement sleeve, wherein the first vertical half and second vertical are not cut prior to coupling.

9. The method of claim 8, wherein coupling the first vertical half to the second vertical half comprises forming the impingement sleeve with only two couplings where longitudinal edges of the first vertical half and second vertical half abut each other.

10. The method of claim 9, wherein coupling the first vertical half to the second vertical half comprises welding a strip that runs longitudinally along each of the two couplings.

11. The method of claim 9, wherein the two couplings are longitudinal couplings that are diametrically opposed couplings located at a center of a top of the impingement sleeve and a center of a bottom of the impingement sleeve.

12. The method of claim 8, wherein coupling the first vertical half to the second vertical half comprises welding the first vertical half to the second vertical half.

13. The impingement sleeve manufactured by the method of claim 12.

14. The method of claim 8, wherein forming the first vertical half comprises pressing the first metal sheet a plurality of times in a plurality of dies to form the first vertical half and wherein forming the second vertical half comprises pressing the second metal sheet a plurality of times in a plurality of dies to form the second vertical half.

15. A method of manufacturing an impingement sleeve for a turbine engine combustor, the method comprising:
placing a first metal sheet in a first die;
pressing the first metal sheet in the first die to form a first vertical half of the impingement sleeve;
placing a second metal sheet in a second die;
pressing the second metal sheet in the second die to form a second vertical half of the impingement sleeve;
forming holes in the first vertical half and second vertical half;
positioning the first vertical half and second vertical half about a transition piece; and
welding the first vertical half to the second vertical half to form the impingement sleeve with only two couplings where longitudinal edges of the first vertical half and second vertical half abut each other.

16. The method of claim 15, wherein welding the first vertical half to the second vertical half comprises welding a strip longitudinally along each of the two couplings.

17. The method of claim 15, wherein pressing the first metal sheet in the first die to form the first vertical half comprises pressing the first metal sheet a plurality of times to form the first vertical half and wherein pressing the first metal sheet in the first die to form the first vertical half comprises pressing the first metal sheet a plurality of times to form the first vertical half.

18. The method of claim 15, wherein the two couplings are longitudinal couplings that are diametrically opposed couplings located at a center of a top of the impingement sleeve and a center of a bottom of the impingement sleeve.

19. The method of claim 15, wherein the first vertical half and second vertical half are not cut prior to welding.

20. The method of claim 15, wherein forming holes in the first vertical half and second vertical half comprises laser drilling the holes in the first vertical half and second vertical half.
